(19) United States
(12) Patent Application Publication
(10) Pub. No.: US 2010/0059999 A1
(43) Pub. Date: Mar. 11, 2010

(54) Sea Floor Pump Tailrace Hydraulic Generation System

(76) Inventor: Ching-Shih TENG, Jhonghe City (TW)

Correspondence Address: SINORICA, LLC, 2275 Research Blvd., Suite 500, ROCKVILLE, MD, 20850, US

(21) Appl. No.: 12/207,484

(22) Filed: Sep. 9, 2008

(51) Int. Cl. F03B 13/26

(52) U.S. Cl. 290/42

(57) ABSTRACT

A small or medium size hydraulic generation plant with a steel shell is placed on the sea floor of the stronger tidal/ocean current site. It is added an air hose to get the fresh air, and an entrance for the technician entering, at out side, the plant is connected with three tidal speed meters, a sea floor cable, an inland remote supervision and control center and a group of tailrace pipe of which the branch pipes of which the branch pipes are connected with a tidal/ocean turbine pump farm.

In operation, the plant bring in the sea floor water to generate electricity on large scale. The electricity is transmitted to land by the sea floor cable, while the tailrace firstly drops to the tailrace pond and continually flows thru the tailrace pipes to the turbine pump farm, at last, it is pumped out to the sea floor by the tidal/ocean turbine pump farm.

### BACKGROUND OF THE INVENTION

1. Field of the Invention

The present invention relates to a sea floor pump tailrace hydraulic generation system in higher tidal/ocean current speed site, and more particularly, to a hydraulic generation system which brings in water at the sea floor to generate power based on its potential and to send the generated power via sea floor cable to the land. While the tailrace is pumped into sea floor by the tidal current pump farm.

2. Description of the Prior Art

Generally there are two ways to use tidal power, one is to build retaining wall, the other is to use turbine, while the former must rely on the topography and the height of the tidemark, it is rarely deployed; the latter relies on turbines with big size and high efficiency, each turbine is equipped with a gear box to drive a small size generator to generate electricity, however, small generators have high costs and short lifetime, it is not available for commercial use on a large scale.

Therefore, the experimental tidal power generation models present several shortcomings to be overcome.

In view of the above-described deficiencies of the experimental tidal power generation models, after years of constant effort in research, the inventor of this invention has consequently developed and proposed a sea floor tailrace extracted hydraulic generation system in the present invention.

### SUMMARY OF THE INVENTION

It is an object of the invention to firstly bring in sea floor water entering sea floor generation plant for generating the large scale electricity with the potential of sea floor water and secondly to pump out the tailrace back to sea floor with the sea floor tidal/ocean turbine pump farm.

It is another object of the invention to provide a sea floor pump tailrace hydraulic generation system which detects the flow speed of the tidal/ocean current to adjust the number of the operating turbine pump so to equalize the capacity of the operating tidal/ocean turbine pumps and the volume of the tailrace.

In order to achieve the above objects, the sea floor pump tailrace hydraulic generation system at least comprises a sea floor hydraulic generation plant, a sea floor cable, a set of tailrace pipe, an inland remote supervision and control center and few sets of tidal current speed meters. The sea floor hydraulic generation plant is a small or medium size hydraulic generation plant with a steel shell, it is placed at the sea floor of the stronger tidal current area, with the depth between 20 meters and 70 meters for generating electricity which is transmitted to land by sea floor cable. While the tailrace flows a set of tailrace pipes to the connected tidal/ocean turbine pump farm, then the turbine pump farm unceasingly pump out the tailrace to sea floor.

### BRIEF DESCRIPTION OF THE DRAWINGS

FIG. 1 illustrates a structural view of a sea floor pump tailrace hydraulic generation system in the present invention;

FIG. 2A illustrates a structural view of a sea floor pump tailrace hydraulic generation plant in the present invention;

FIG. 2B illustrates the interior structural view of the sea floor pump tailrace hydraulic generation plant in the present invention;

FIG. 2C illustrates a frontal view of the water inflow of the sea floor pump tailrace hydraulic generation plant in the present invention;

FIG. 3 illustrates a structural view of a tailrace pipe of the sea floor pump tailrace hydraulic generation system in the present invention;

FIG. 4 illustrates a operational view of three tidal speed meters and the dial-face of controlling meter of the sea floor pump tailrace hydraulic generation system in the present invention;

FIG. 5A illustrates a view where an tailrace pond level adjustment device for tailrace level of the sea floor pump tailrace hydraulic generation plant is at its highest level;

FIG. 5B illustrates a view where the tailrace pond level adjustment device for tailrace level of the sea floor pump tailrace hydraulic generation plant is at its higher level;

FIG. 5C illustrates a view where the tailrace pond level adjustment device for tailrace level of the sea floor pump tailrace hydraulic generation plant is at its standard level;

FIG. 5D illustrates a view where the tailrace pond level adjustment device for tailrace level of the sea floor pump tailrace hydraulic generation plant is at its lower level;

FIG. 5E illustrates a view where the tailrace pond level adjustment device for tailrace level of the sea floor pump tailrace hydraulic generation plant is at its lowest level;

FIG. 6 illustrates structural views of a shoreline tidal turbine pump and an off shore tidal turbine pump in the present invention;

FIG. 7 illustrates a structural view of an entrance of the sea floor pump tailrace hydraulic generation plant for technician in the present invention;

FIG. 8 illustrates a structural view of an air hose device of the sea floor pump tailrace hydraulic generation plant.

### DETAILED DESCRIPTION OF THE PREFERRED EMBODIMENT

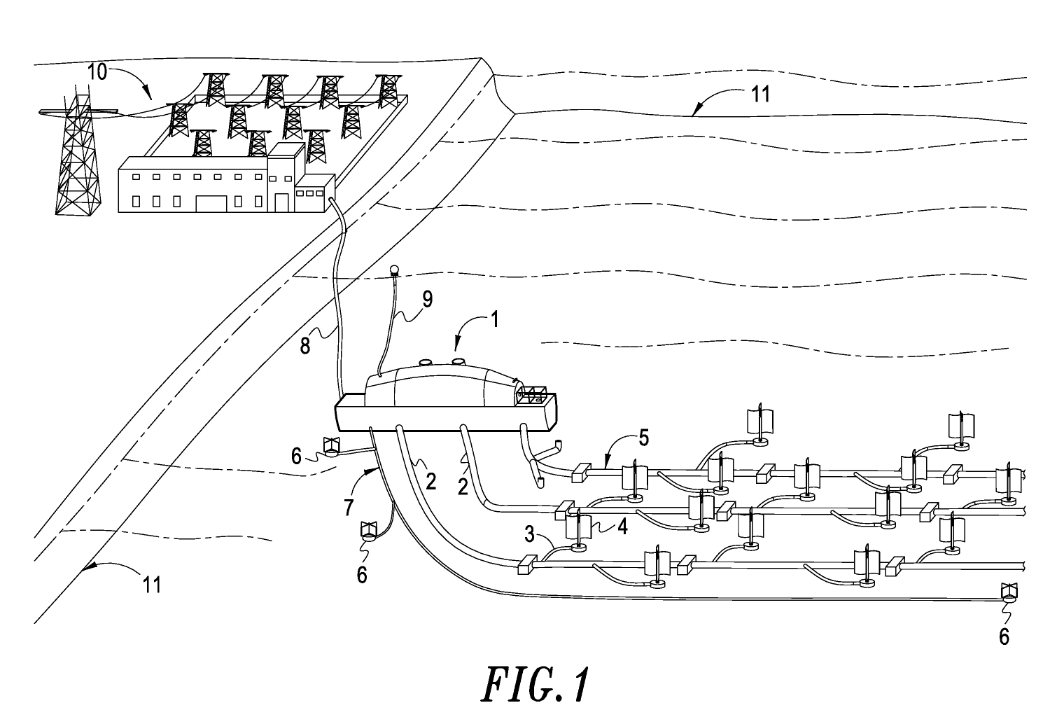

Please refer to FIG. 1 for a structural view of a sea floor pump tailrace hydraulic generation system in the present invention, wherein the system mainly comprises:

a sea floor hydraulic generation plant 1, the sea floor hydraulic generation plant 1 is a small to medium size generation plant with its submarine-shaped hull made of rigid steel, the sea floor hydraulic generation plant 1 is placed on the sea floor 11 of the depth between 20 meters and 40 meters, or the sea floor 11 of the depth between 40 meters and 70 meters; the sea floor hydraulic generation plant 1 is a permanent power generation apparatus which is designed to use material that can last for more than 60 years, the power output is about 20 MW capacity when it is placed on the sea floor 11 of the depth between 20 meters and 40 meters and 50 MW capacity when it is placed on the sea floor 11 of the depth between 40 meters and 70 meters;

a tailrace pipe group comprises tailrace main pipes 2, tailrace branch pipes 3 and tidal turbine pumps 4, each tailrace main pipe 2 is connected to the sea floor hydraulic power generation plant 1 and the tailrace branch pipe 3 respectively, while each tailrace branch pipe 3 has its one end connected to the tidal turbine pump 4; the tailrace main pipes 2, the tailrace branch pipes 3 and the tidal turbine pumps 4 are in charge of draining and pumping out the tailrace;

a tailrace pond level adjustment device for tailrace level 5 is connected to the sea floor hydraulic generation plant 1 to prevent the sudden rise or fall of the tidal speed from affecting the tailrace pond level and to assure normal performance of the generation operation;

three sea floor tidal flow speed meters 6, are disposed around the sea floor hydraulic generation plant 1, the tailrace pipes and the tidal turbine pump farm 4 for more effectively detecting the tidal speed and transmitting the readings via a line 7 to the pump control adjustment device in the plant;

a sea floor cable 8, the electricity generated by the sea floor hydraulic generation plant 1 is transmitted via the sea floor cable 8 to the land;

a air hose device 9, the air hose device 9 is connected to the sea floor hydraulic generation plant 1 to keep the cooling system of the sea floor hydraulic generation plant 1 running and to maintain the atmospheric pressure on the surface of the tailrace pond since the sea floor hydraulic generation plant 1 needs air and a stable atmospheric pressure;

an inland remote supervision and control center 10, the inland remote supervision and control center is placed on the shore and connected to the sea floor hydraulic generation plant 1, which transmits the operation status to the inland remote supervision and control center 10; the technician at the inland remote supervision and control center 10 would know immediately and tries to control or to shut down the operation if the sea floor hydraulic generation plant 1 fails to effectively carry out automatic generate control.

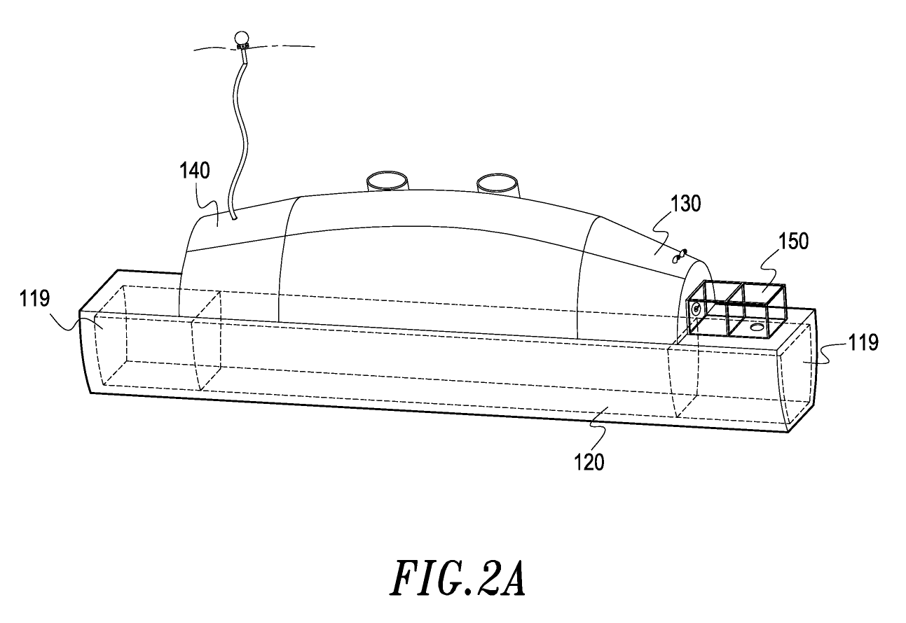

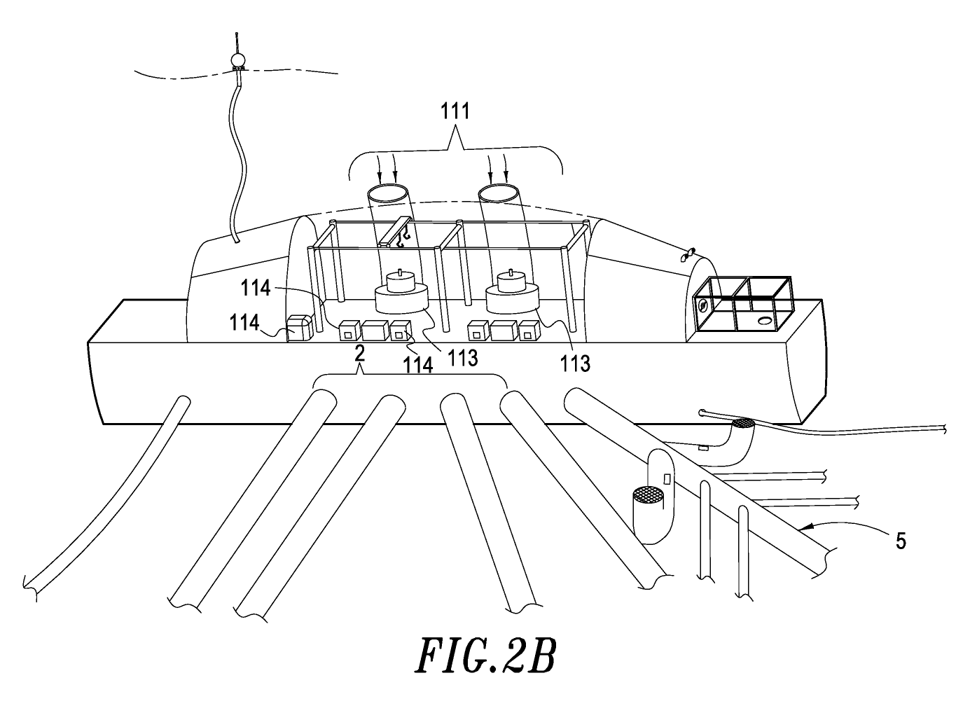

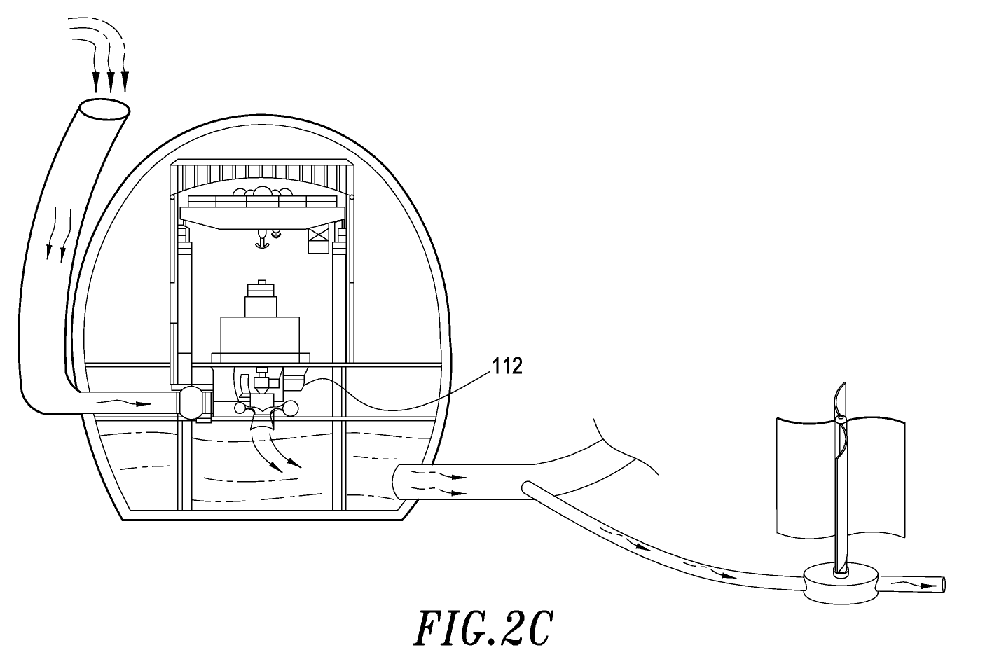

Please refer to FIG. 2A,2B,2C for a structural views of the sea floor hydraulic generation plant, due to that its generation equipment is same as that of the general underground hydraulic generation plant, therefore, a brief explanation is as below;

The plant has a thick, good water seal, steel shell and is divided three floor inside; all generate equipment and few new device such as generators 112, generate control center 130, entrance 150, crane 115, an air hose 116 are installed on the upper floor 116, (the invisible items; the transformer, switch gear, connection of the sea floor cable and also installed on the front and rear part of upper floor 116)

The last section of intake pipe 111 and water turbine 112 are installed in the medium floor 117;

The front and rear parts of the down floor are used as static water chamber 119 to stabilize the plant in sea floor the middle part is used as the tailrace pond 120.

Please refer to FIG. 2C shows a complete processes of how the sea floor water enters to plant to generate electricity, drops to the tailrace pond, flows thru the tailrace main pipe and the branch pipe. At last, it is pumped out to the sea floor by the turbine pump farm.

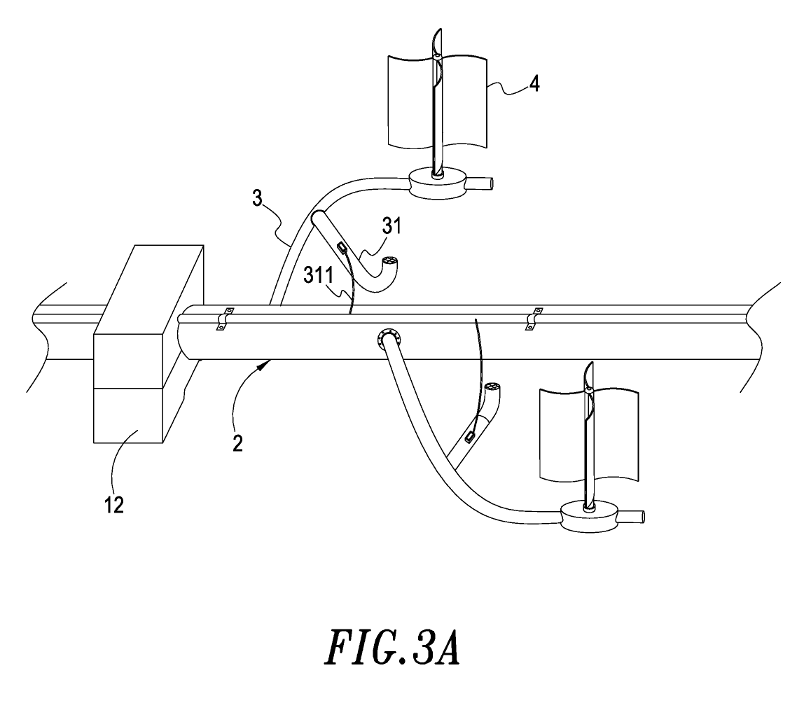

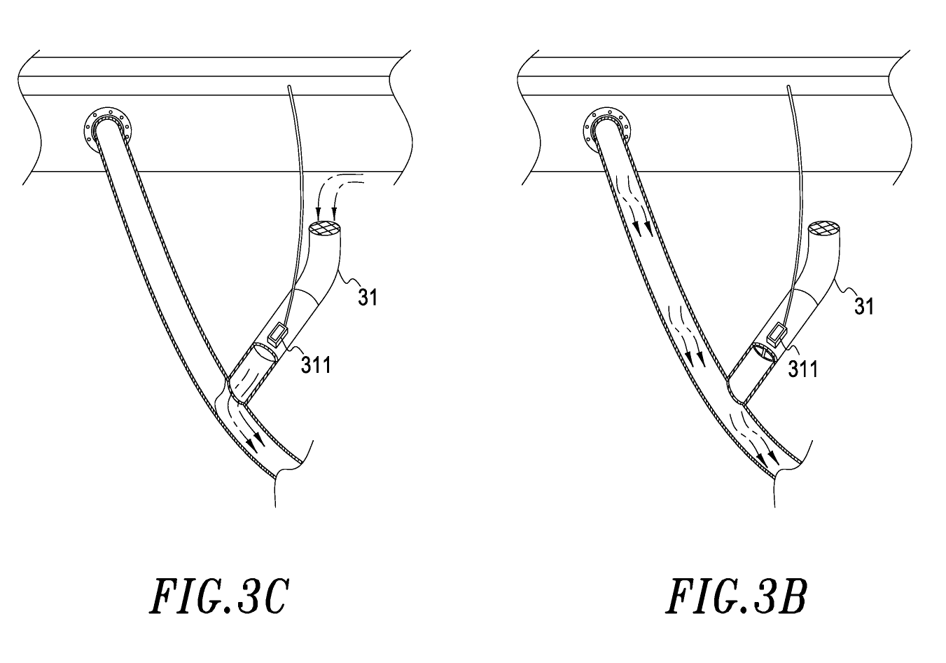

Please refer to FIG. 3 for a structural view of the tailrace pipes of the sea floor pump tailrace hydraulic generation system in the present invention, wherein the tailrace pipes comprises:

Several tailrace main pipes 2, the tailrace main pipe 2 is a steel pipe with large diameter, the number of the tailrace main pipe 2 is 4 to 8, depending on the total volume of the tailrace, each tailrace main pipe is connected with about 20 tailrace branch pipes 3 and one tidal turbine pump 4 on its one end; each tailrace main pipe 2 is about 1,000 meters in length with 20 tailrace branch pipes 3 and tidal turbine pumps 4 connected on each side thereof, each pump is 70-80 meters apart from each other, the tailrace main pipe can contain as many as 20 tailrace branch pipes and is built with material resistant to sea water corrosion for permanent use, wherein a solid pipe holder 12 is deployed to stand the water flush;

the tailrace branch pipe 3, the tailrace branch pipe 3 is a steel pipe in small diameter and equipped with a single direction valve between it and the tailrace main pipe 2 to prevent the tailrace from flowing back to the tailrace main pipe 2, the beginning of the tailrace branch pipe 3 is connected with a pump disability branch pipe 31, which is of the same diameter as that of the tailrace branch pipe 3; the tailrace branch pipe 3 is 40 to 50 meters in length to be spaced apart from the tidal turbine pump 4 connected to its end;

the tidal turbine pump 4, the tidal turbine pump 4 is connected to one end of the tailrace branch pipe 3 and driven continuously by the tidal flow; when the tidal speed is high, the number of the tidal flow turbine pump 4 must be reduced, when the tidal speed is low, the number of the tidal turbine pump 4 should be increased to let the volume of the tailrace brought in equal to the volume of the extraction, therefore a pump disability branch pipe 31 is designed to keep the pump idle running without draining/discharging the tailrace;

the pump disability branch pipe 31 is disposed close to the place where the tailrace branch pipe 3 connects with the tailrace main pipe 2, the diameter of the pump disability branch pipe 31 is the same as that of the tailrace branch pipe 3, the length of the pump disability branch pipe 31 is about 2 meters, a strainer is disposed at the end of the pump disability branch pipe 31 with a power wire and solenoid valve switch 311 in closed state (please refer to FIG. 3B); the tidal turbine pump 4 becomes idle running, when the pump control adjustment device turns on the solenoid valve switch to let sea floor water flow through the strainer of the pump disability branch pipe 31 to the tailrace branch pipe 3 to press close the single direction valve of the tailrace branch pipe 3 and let sea floor water flow through the pump disability branch pipe 31 to the turbine pump to disable the tidal flow turbine pump 4 temporarily to stop draining/pump the tailrace (please refer to FIG. 3C); besides, the pump disability branch pipe 31 is controlled based on the sequence of the tailrace main pipe 2 (one to four in turn) so as to balance the number of each tailrace main pipe 2 to be as close as possible (preferably equal).

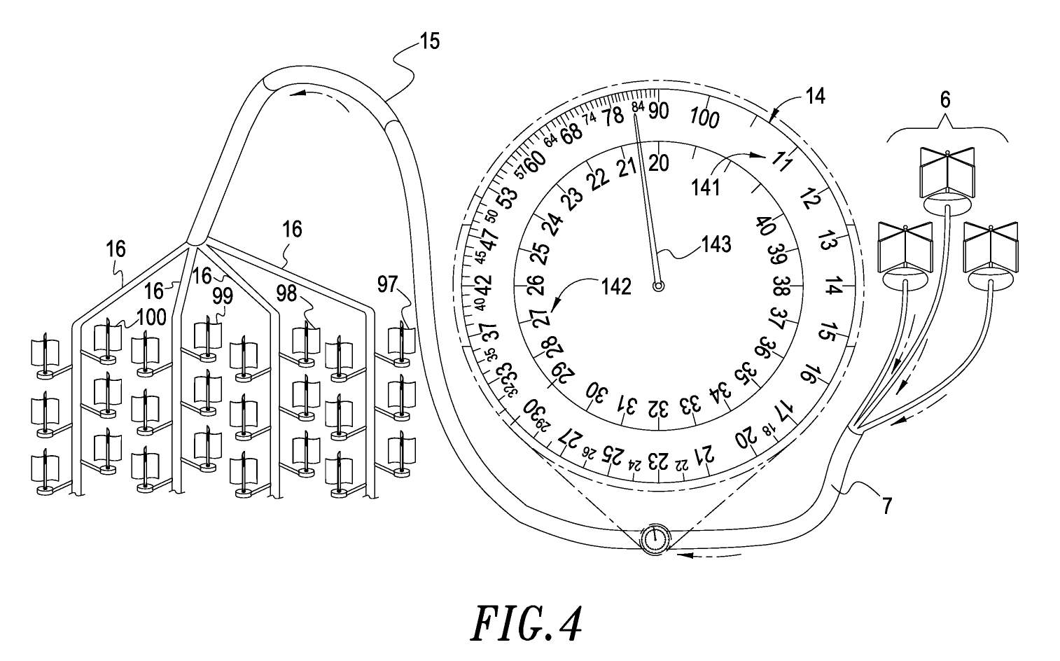

Please refer to FIG. 4 for an operational view of three tidal speed meters of the sea floor pump tailrace hydraulic generation system in the present invention, it is necessary to monitor the tidal speed since the system is provided for tidal power generation, as the speed changes frequently, so three sea floor tidal speed meters 6 are disposed around the sea floor hydraulic generation plant, the tailrace pipes and the tidal turbine pump for sending the readings through the line 7 to the pump control device 14 in the power generation control center of the sea floor hydraulic generation plant, the pump control meter 14 comprises a pump quantity meter 141, a tidal speed meter 142 and a pointer 143, the pointer marks the speed, the lowest speed marked is adopted to adjust the number of the pumps through a pump disability control wire 15; when the speed is high, less pumps are used, when the speed is low, more pumps are used, and the adjustment will be processed according to a pump control sequence 16.

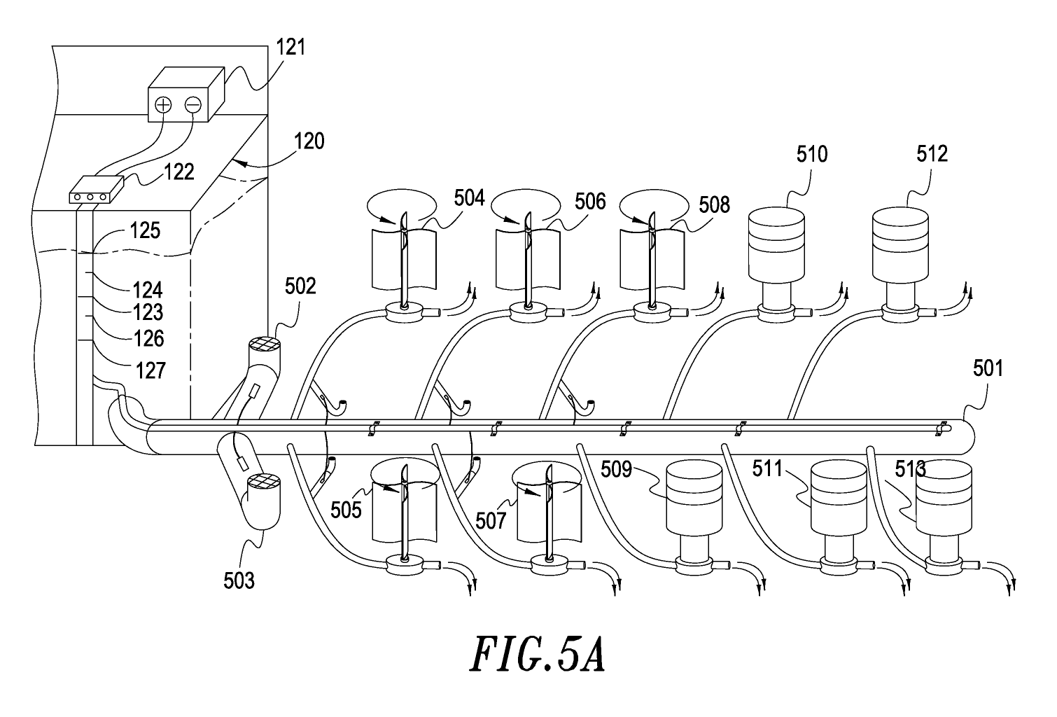

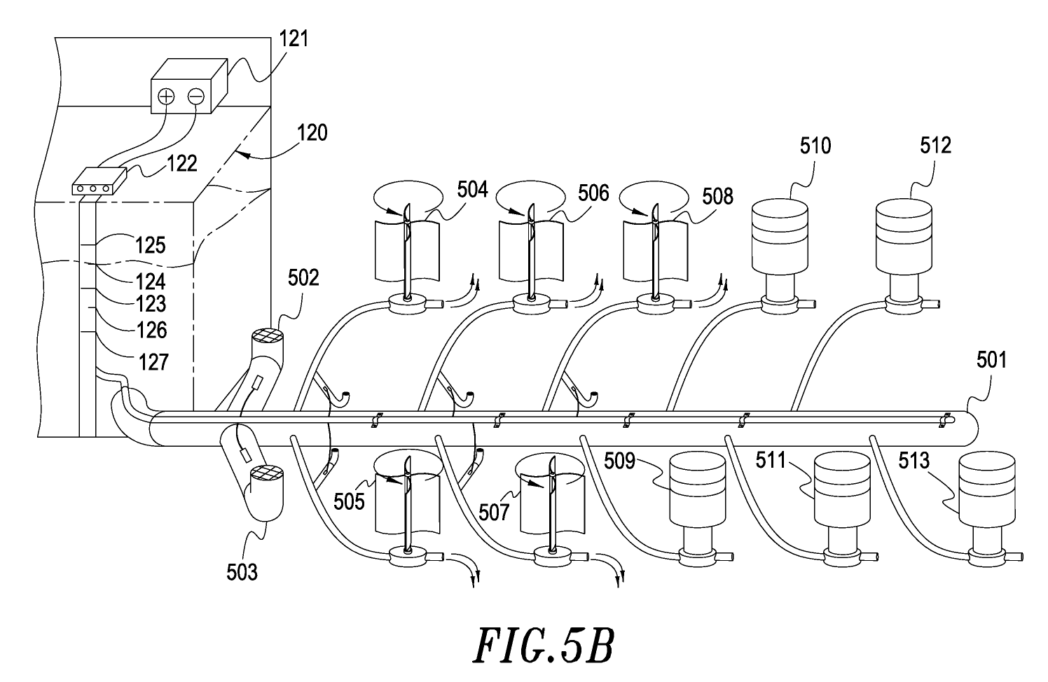

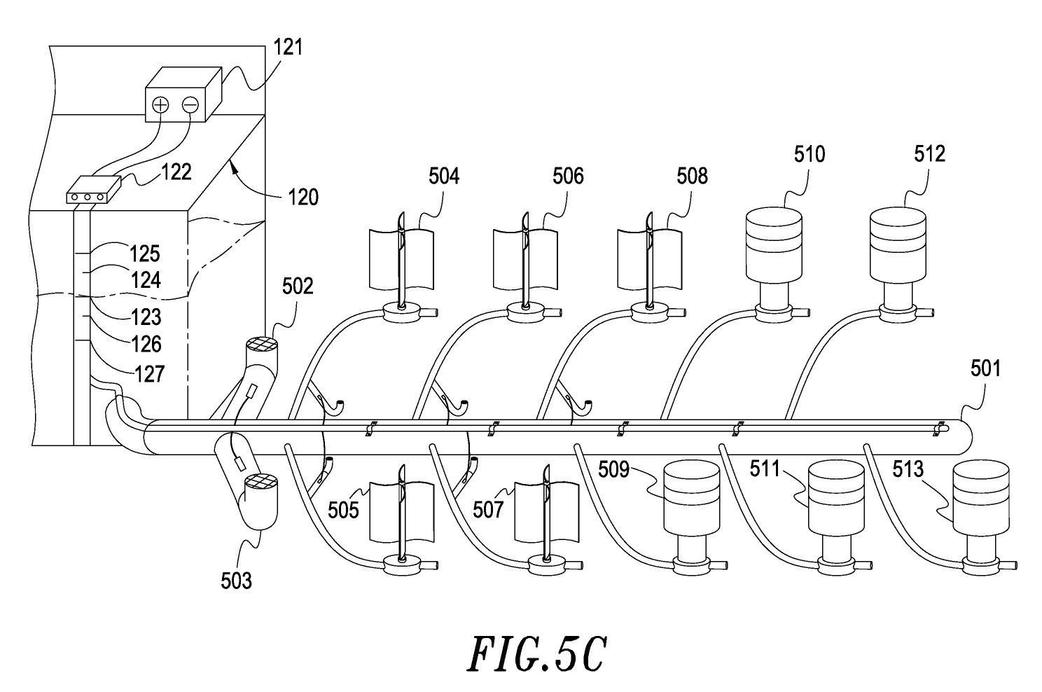

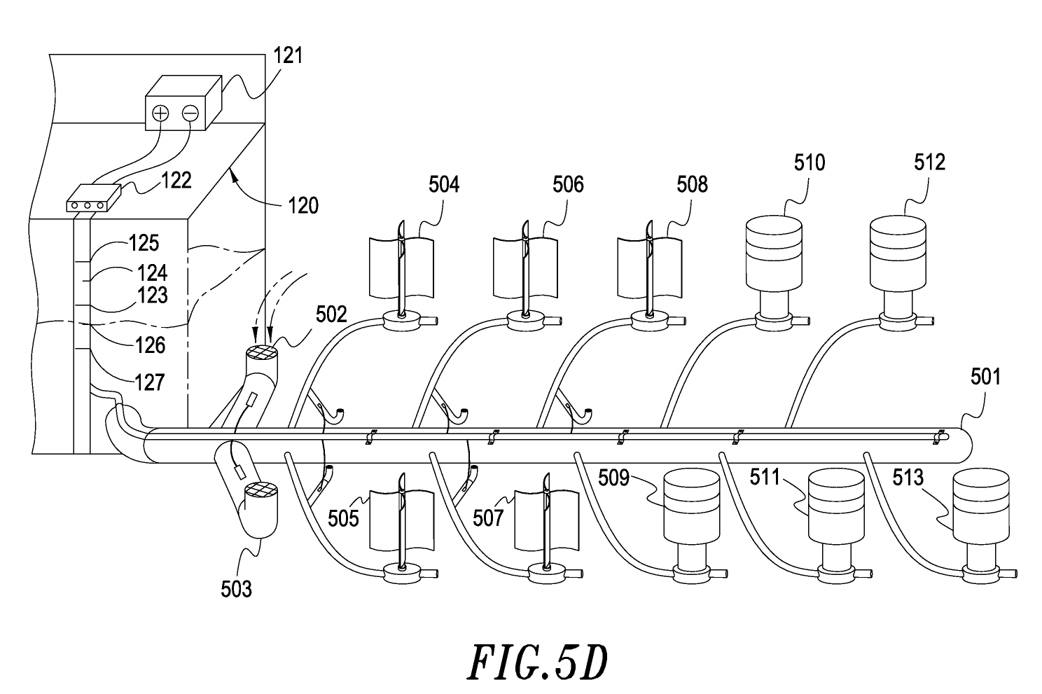

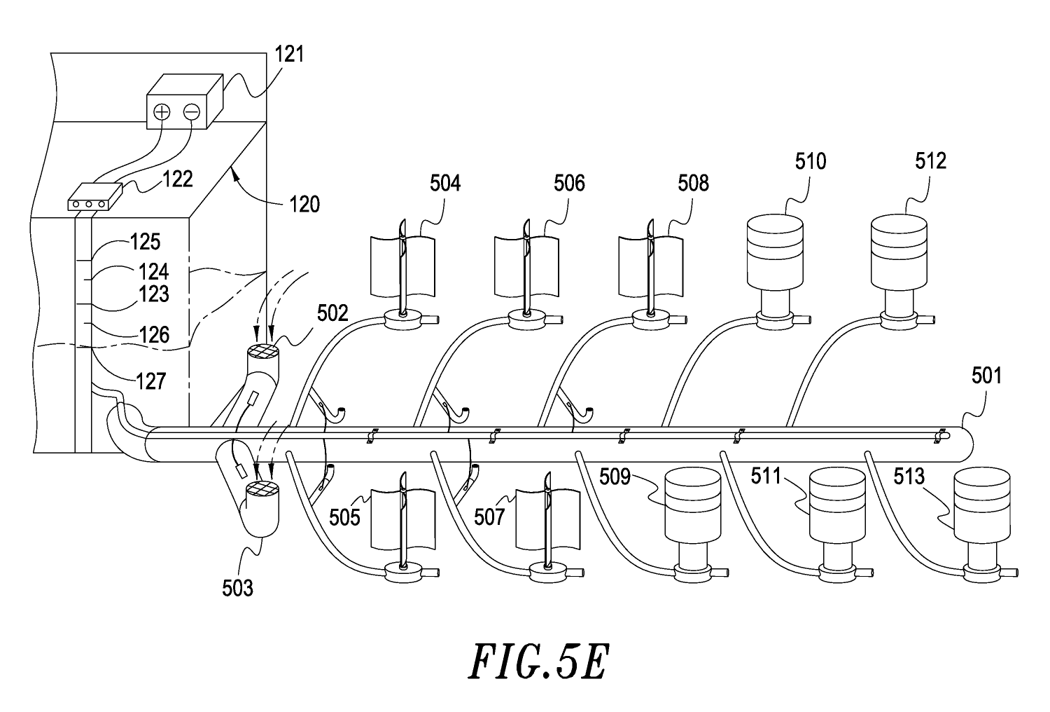

Please refer to FIG. 5A to FIG. 5E for views of tailrace pond level adjustment device for tailrace level of the sea floor pump tailrace hydraulic generation plant, in the figure, the tailrace pond level adjustment device for tailrace level uses a tailrace adjustment pipe 501 having a size as same as that of the tailrace main pipe and lying parallelly with other tailrace main pipes to connect to the down floor tailrace pond 120 of the sea floor hydraulic generation plant, there are five tailrace level switches (123, 124, 125, 126, 127) in the down floor tailrace pond 120; besides, the tailrace adjustment pipe 501 is equipped with two solenoid valve controlled intake pipes 502, 503 having the same diameter, five tidal turbine pumps (504 to 508) each with a capacity of about one cubic meter and five electrical pumps (509 to 513) in the rear, each with a capacity of two cubic meter; ordinarily, the tailrace adjustment pipe 501 is filled with static tailrace, two solenoid valve controlled intake pipes (502, 503) are closed, and the tidal turbine pumps (504 to 508) and the electrical pumps (509 to 513) are in the closed state to prevent the sudden rise or fall of the tidal flow rate from affecting the tail water level, when the tail water level becomes too high or too low, the tailrace adjustment pipe 501 operates to keep the tail water level at normal level.

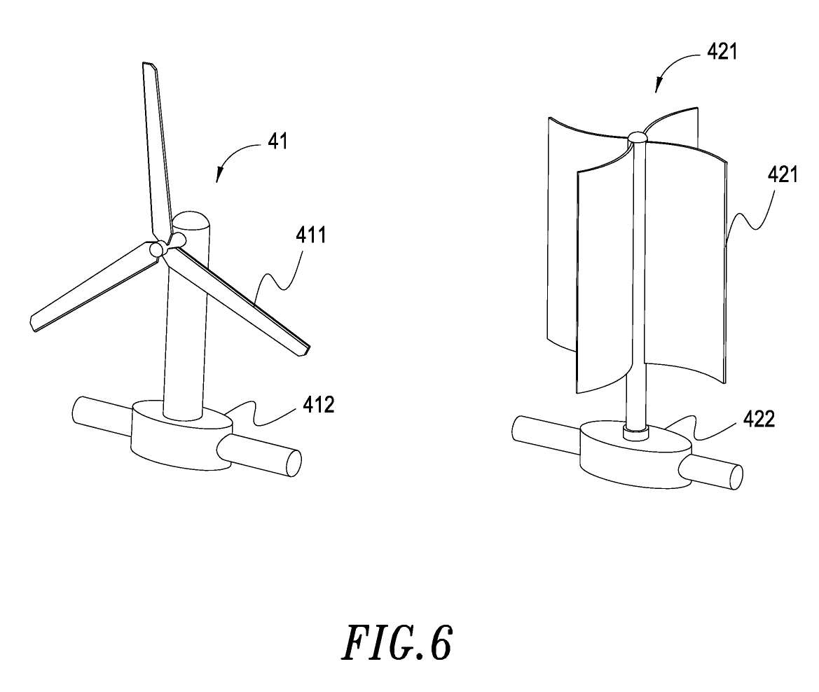

Please refer to FIG. 6 for structural views of a shoreline tidal turbine pump and an off shore tidal turbine pump in the present invention, in this figure, the shoreline turbine pump 41 is preferably a wind propeller turbine 411 because near the shoreline the tidal direction is usually back and forth; on the other hand, the offshore turbine pump 42 is preferably a vertical axle roll door turbine 421 to obtain the best efficiency because the tide flow is often combined with ocean current, which tends to have variable speeds and flow directions; besides, gear boxes and pumps (412, 422) in the shoreline/off shore tidal flow turbine can convert the tidal power into mechanical energy for increasing a rotating speed of an accelerating gear set to drive pump to pump out the tailrace to sea floor.

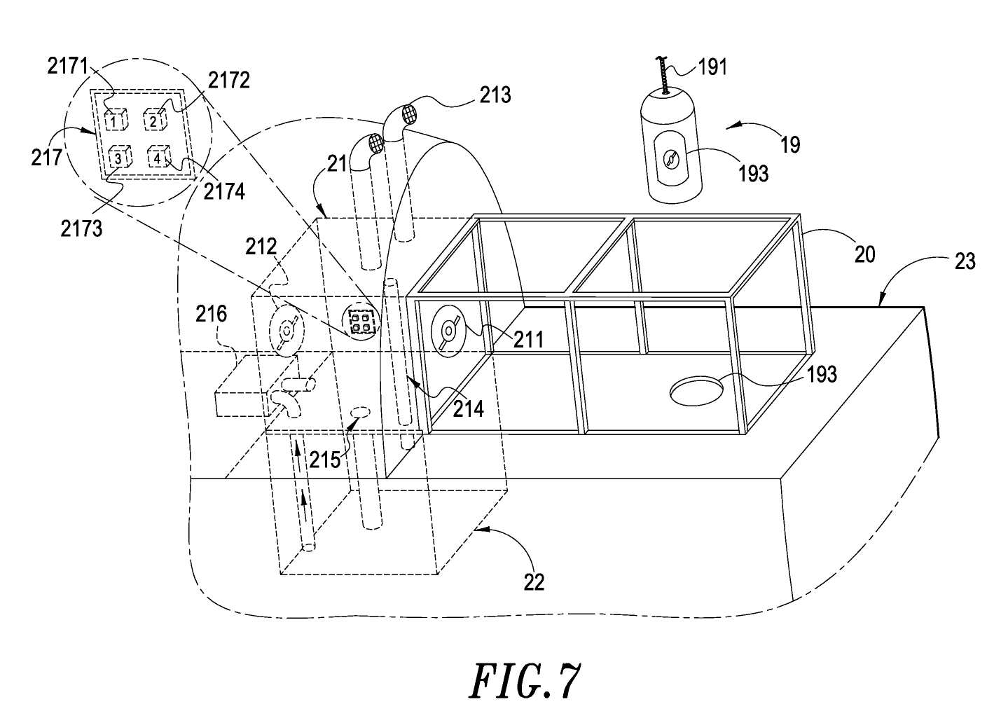

FIG. 7 illustrates a structural view of an entrance of the sea floor pump tailrace hydraulic generation plant for technician in the present invention, the entrance mainly comprises:

a diving bell 19, the diving bell 19 is connected to a suspending steel chain 191, the suspending steel chain 191 hangs and lowers the diving bell 19 down to a frame consisted of steel columns 20 and places the diving bell 19 on a drop zone mark 192, then the technician can open the diving bell door 193 and reaches a door of a preparatory room 21;

steel columns 20, the steel columns 20 is mounted and fixed to the top of the front part of plant 23, the frame consisted of steel columns is used for fixing the descending diving bell;

the preparatory room 21, the preparatory room 21 is disposed on the upper floor of the hydraulic power generation plant and connected to the steel columns 20, the preparatory room 21 comprises a first door 211, a second door 212, sea water pressure tubes 213, an air hose 214, a water discharging pipe 215, an electrical pump 216 and a first to a fourth switches 217; the technician can ride the diving bell 19 to the top of the hydraulic generation plant and goes through the frame consisted of the steel columns 20 to reach the first door 211 of the preparatory room 21, finally the technician passes through the second door 212 of the preparatory room 21 to be inside the sea floor hydraulic generation plant for vital maintenance and adjustment;

When there's no technician in the sea floor hydraulic generation plant, two sea water pressure tubes 213 are in open state, and the air hose 214 and the water discharging pipe 215 are in closed state, meanwhile, the electrical pump 216 is stopped; when the technician enters the preparatory room 21, the first to the fourth switches 217 are operated to adjust the air, pressure and water volume for letting the technician get in and out of the hydraulic generation plant;

a water containing room 22, the water containing room 22 is disposed inside the down floor tailrace pond with a volume slightly larger than that of the preparatory room 21 so as to contain all the sea water discharged by the preparatory room, when there's no technician in the preparatory room 21, the water containing room 22 is filled with air with no water in it.

because the sea floor hydraulic generation plant is fully automatic controlled, there's usually no technician in the power plant, when it is necessary to perform critical maintenance works, the technician can use the diving bell to enter/leave the sea floor hydraulic generation plant, the implementations are described below:

a. The technician wears diving suit to enter the diving bell, the ship on the sea surface hangs the diving bell and lowers it down to the frame consisted of steel columns;

b. The technician opens the first door of the preparatory room and enter the preparatory room, then the technician shuts down the first door and press the sea water pressure tube switch to close the valve between two sea water pressure tube;

c. The technician presses the air hose switch and then presses the water discharging pipe switch to open the discharging hole of the preparatory room to discharge the sea water in the preparatory room to the water containing room right down below, the air in the water containing room is pushed to flow to the preparatory room through the air hose, the sea water in the preparatory room will all be discharged to the water containing room within two minutes to fill the preparatory room with air, then the technician presses the air hose switch and the water discharging pipe switch again to close the discharging hole;

d. The technician opens the second door of the preparatory room and enters the sea floor hydraulic generation plant, then the technician closes the second door;

e. When the technician is to leave the sea floor hydraulic generation plant, the technician opens the second door to enter the preparatory room and then closes the second door, presses the air hose switch to open the air hose;

f. The technician presses the electrical pump switch to activate the electrical pump to pump the sea water in the water containing room to the preparatory room, the air in the preparatory room will be pushed through the air hose to the water containing room, the preparatory room will be filled with sea water, then the technician can press the electrical pump to stop;

g. The technician presses the air hose switch to close the air hose valve in the preparatory room, then the technician presses the sea water pressure tube switch to open two pressure hole to let the pressure of the sea water in the preparatory room equal to that of the sea water at the sea floor; then the technician opens the first door to leave sea floor hydraulic power generation plant, then the technician enters the diving bell to be brought back to the ship.

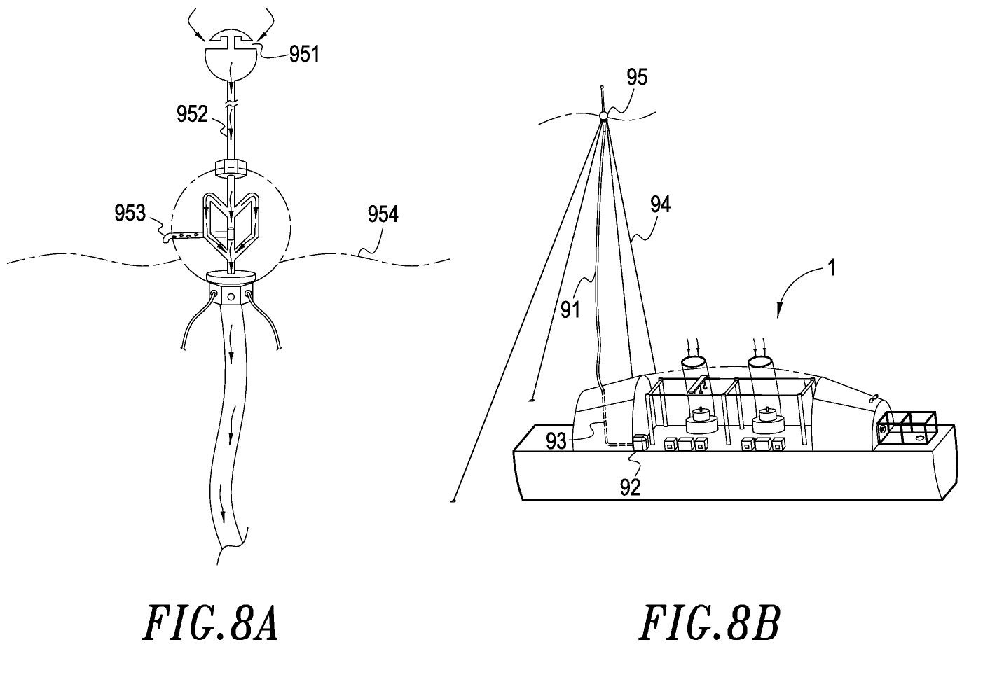

FIG. 8 illustrates a structural view of an air hose device of the sea floor pump tailrace hydraulic generation system, wherein the air hose comprises:

an air rubber hose 91, the air rubber hose 91 is made of thick rubber and extended from the sea floor hydraulic generation plant 1 to the sea surface, an air metal ball 95 is held by a mooring cable 94 to stay at the sea level 954, the top of the air metal ball 95 is connected to a two meter long air metal hose to let the air and spray enter the air metal ball 95 through the entrance of the air hose 951 and the air hose 952, the spray is filtered by a discharging water tube and cup to let only the air enter the air rubber hose 91;

an air container 92, the air container 92 is disposed inside the sea floor hydraulic generation plant 1, when the technician in the sea floor hydraulic power generation plant 1 needs more fresh air, the air container 92 opens and releases air into the sea floor hydraulic generation plant 1;

a mini air pump 93, the mini air pump 93 is disposed inside the sea floor hydraulic generation plant 1, when the air stored in the air container tube 92 is not enough, the mini air pump 93 turns on to absorb air from the sea surface and stores the air in the air container 92;

The air hose device is used for adjusting the air quality of the hydraulic generation plant because the sea floor hydraulic generation plant needs air and stable atmospheric pressure to keep the cooling system running and to maintain the atmospheric pressure of the surface of the tail water pond.

The sea floor pump tailrace hydraulic generation system disclosed in the present invention can use tidal power at the sea floor to generate power, whose operations are described below:

### 1. Preparation for Power Generation

When all devices are installed and tested, they can be adjusted to be prepared for power generation, the adjustments are:

a. Open the intake pipe of the sea floor hydraulic generation plant for a minimum opening to let a small volume of sea water in to fill the water turbine (not activated) and to let the water enter the tailrace main pipe, branch pipes and every turbine pump, finally, keep the tail water pond level at standard level;

b. Fill the tailrace main pipes, branch pipes and turbine pump farm with sea water, at this stage the tidal turbine pumps are in idle running state;

c. Then fill the tailrace level adjustment device with sea water, let two solenoid valve controlled intake pipes be in closed state, five tidal turbine pumps and five electrical pumps are stopped.

### 2. The Process of the Generation

The generate control center slowly open intake to about 90% opening to bring in the sea floor water flows thru the short and thick intake, to water turbine and drive water turbine and the generator producing the electricity. Due to that it is a 100% out put generation, the tailrace is in fixed volume.

The electricity is transmitted to the grid system in land by the sea floor cable.

The tailrace firstly drops to the tailrace pond in down floor and then flows to a number of the main tailrace pipe and their affiliated branch pipes. The tidal turbine pump farm connected therewith.

The pump control adjustment device, based on the different tidal speeds, adjusts the proper number of the operating pump to unceasingly pump out the tailrace to sea floor.

### 3. The Advantages of the Sea Floor Pump Tailrace Hydraulic Generation System;

The sea floor pump tailrace hydraulic generation system disclosed in the present invention, while compared with other experimental energy models, is advantageous in:

1. While all the land sites suitable for hydraulic power generation are developed. Now the tidal/ocean and wave energy have become new focus for many countries. However, in all experimental models, tidal turbine combine with a small generator has been proposed for many years, due to its high cost and maintenance expenses and short life span, it is not available for generation on a large scale; While the present invention gathers the tidal/ocean energies from large ocean area to generate the commercial electricity, the apparatus of the system(except for the tidal turbine pump) can last very long so to set off the installation cost, therefore, it is a new way to harness the tidal/ocean energies for large scale electricity.

2. The present invention disclosed a sea floor pump tailrace hydraulic generation system which is involved in techniques such as shipbuilding, hydraulic power generation, under water engineering for facilitating manufacturing, operation and maintenance. Besides, the whole system is placed on the sea floor to avoid the danger of the storm, it is clean to the environment; it will not hinder the course of the ships as well. Furthermore the present invention can generate electricity with a plurality of the same system for producing more electricity.

3. To compare the tidal turbine pump set of this system to the turbine generator set of the experimental tidal models, the former is higher in efficiency, lower in installation cost, longer in life span, simpler in maintenance than that of the latter; many changes and modifications in the above described embodiment of the invention, of course, be carry out without departing from scope thereof. Accordingly, to promote the progress in science and the useful arts, the invention is disclosed and is intended to be limited only by the scope of the appended claims.

What is claimed is:

1. A sea floor pump tailrace hydraulic generation system at least comprising:
a sea floor hydraulic generation plant placed on the sea floor of the stronger tide area, the sea floor hydraulic generation plant brings in water pressed at the sea floor to the plant to drive the water turbine and the generator to generate electricity, the electricity is transmitted to land via the sea floor cable, and the tailrace drops to the tailrace pond and then to the tailrace main pipes connected to the down floor tailrace pond;
a set of tailrace pipe comprising a plurality of tailrace main pipes, a plurality of tailrace branch pipes and a plurality of tidal turbine pumps each one of the tailrace main pipe being connected to few tailrace branch pipes, with an end of the tailrace branch pipe connecting to one tidal turbine pump for the tailrace to flow through the tailrace main and branch pipes and finally to the plurality of tidal turbine pumps distributed over a large area; when the tidal turbine pumps are driven by the tidal current, the turbine pumps continue to pump out the tailrace to the sea floor to complete the full circle of bring in the sea floor water for electricity generation and pumping out the tailrace to sea floor;
an automatic adjustment device in the plant, comprising a tidal current speed meter, a turbine pump disable device per each turbine pump, an intake pipe and an electrical pump, based upon the tidal current speed to adjust the proper number of the operating turbine pump and decreasing/increasing water volume for tailrace pond, thus assuring the smooth running of the tailrace and the generating of the electricity.
